(19) United States
(12) Patent Application Publication
(10) Pub. No.: US 2005/0072674 A1
(43) Pub. Date: Apr. 7, 2005

(54) Method and device for introducing a sample into an electrophoretic apparatus

(75) Inventors: Karen Heins, Hampstead, NH (US); Kevin McKernan, Marblehead, MA (US); Adrianne D. Brand, Wenham, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Agencourt Bioscience Corporation, Beverly, MA (US)

(21) Appl. No.: 10/678,960

(22) Filed: Oct. 3, 2003

(51) Int. Cl. G01N 27/453

(52) U.S. Cl. 204/451; 204/601

(57) ABSTRACT

A method and device for introducing a sample, such as a nucleic acid sample, into an electrophoretic apparatus is provided in which the sample is introduced into the electrophoretic apparatus in the presence of a magnetic field. In a particular embodiment, the electrophoretic apparatus can include a nucleic acid sequencer. The sample can be introduced into the electrophoretic apparatus electrokinetically. The magnetic field attracts one or more magnetic microparticles that can be suspended or otherwise provided in the sample. The nucleic acid sample can be bound to one or more magnetic microparticles. In particular embodiments, the microparticles can be used to purify dye terminator sequencing reactions. The magnetic field can be formed by a rare earth magnet, such as neodymium, or by an electromagnet, or other suitable means. In particular embodiments, the sample can be injected into a nucleic acid sequencer by capillary electrophoresis and sequenced by the sequencer.

### BACKGROUND OF THE INVENTION

Electrophoresis is an electrochemical process in which molecules with a net charge migrate in a solution under the influence of an electric current. Traditionally, slab gel electrophoresis has been a widely used tool for analysis of genetic materials. See, for example, G. L. Trainor, Anal. Chem., 62, 418-426 (1990). Recently, capillary electrophoresis (CE) has emerged as a powerful separations technique, with applicability toward a wide range of molecules from simple atomic ions to large DNA fragments. In particular, CE has become an attractive alternative to slab electrophoresis (SGE) for biomolecule analysis, including DNA sequencing (Baba, Y., et al., Trends in Anal. Chem., 11:280-287 (1992)).

Molecular biology applications such as electrophoresis (e.g, capillary electrophoresis) and nucleic acid sequencing require isolation of high quality nucleic acid and polypeptide preparations. Methods for obtaining such high quality preparations are known in the art, however, the methods often involve several steps, which increases sample loss and cost.

A need exists for improved methods of obtaining high quality nucleic acid and polypeptide preparations for use in molecular biology applications such as electrophoresis and nucleic acid sequencing.

### SUMMARY OF THE INVENTION

The isolation of high quality nucleic acid preparations from starting solutions of diverse composition and complexity is fundamental in molecular biology. Novel and readily available methods for doing so are known in the art. For example, high quality nucleic acid preparations can be obtained by selectively facilitating the adsorption of nucleic acid to the functional group coated surface of magnetically responsive microparticles group (see, for example, U.S. Pat. No. 5,705,628; U.S. Pat. No. 5,898,071; U.S. Pat. No. 6,534,262 and U.S. Published Application No. 2002/0106686, all of which are incorporated herein by reference in their entirety). Separation is accomplished by manipulating the ionic strength and polyalkylene glycol concentration of the solution to selectively precipitate, and reversibly adsorb, the nucleic acid to magnetic microparticles. The nucleic acid is isolated from a starting mixture through the removal of the magnetic beads to which the nucleic acid has been adsorbed. Such methods provide a means of nucleic acid isolation and purification which produces high quality nucleic acid molecules for capillary electrophoresis and nucleic acid sequencing.

Magnetic microparticles (beads) are an ideal reagent for purifying sequencing reactions (e.g., dye terminator sequencing reaction products) to be detected on a nucleic acid sequencer. However, magnetic beads can interfere with the injection of the purified nucleic acid sample into a nucleic acid sequencer. This is presumably due to the magnetic microparticle's high mass to charge ratio and injection competition. Common phenotypes of bead interference are delayed start points and reduced mobility. High molecular weight (HMW) DNA has been known to produce a similar artifact with linear polyacrylamide (LPA) based sequencing polymers (Coope, et al. from the Department of Physics and Astronomy of the University of British Columbia).

Magnetic microparticles can be readily removed from the solution with the use of a magnet plate, however, this requires transferring the cleared samples to a new microparticle free plate, which is an additional, inconvenient step that results in a loss of sample and an increase in cost. The ability to directly inject the nucleic acid sample in the presence of magnetic beads would greatly simplify the process and generate more accurate results.

As described herein, Applicants provide a magnet plate compatible with nucleic acid sequencers which circumvents the microparticle removal step. The plate allows direct injection of nucleic acid eluted from magnetic microparticles while the microparticles are present in the sequencing plate, which occurs with minimal injection interference. In one embodiment, nucleic acid sequencing is performed in an automated sequencer by capillary electrophoresis.

Accordingly, the present invention is directed to a method of introducing a sample into an electrophoretic apparatus or nucleic acid sequencer comprising introducing the sample into the electrophoretic apparatus or nucleic acid sequencer in the presence of a magnetic field.

In accordance with one aspect of the present invention, a magnetic field can be applied to the plate containing the sample during introduction of the sample into an electrophoretic apparatus (e.g., a nucleic acid sequencer in which the sequencing is performed by capillary electrophoresis), such that the step of removing the magnetic microparticles is beneficially avoided. In one embodiment, the sample is introduced into the electrophoretic apparatus electrokinetically.

In a particular embodiment, the magnetic field attracts one or more magnetic microparticles that can be suspended or otherwise provided in the sample. The nucleic acid, which is bound to the magnetic microparticles, is eluted from the microparticles using a suitable elution buffer. A magnetic field can be applied to the plate containing the sample during introduction of the sample into an electrophoretic apparatus, such as a nucleic acid sequencer, such that the step of removing the magnetic microparticles is beneficially avoided. The microparticles can be used to purify, for example, dye terminator sequencing reactions, dye primer reactions and combinations thereof. The magnetic field can be formed by a rare earth magnet, such as neodymium, or by an electromagnet, or other suitable means.

In particular embodiments, the sample can include a nucleic acid sample such as DNA, RNA or polyamide nucleic acid (PNA) samples. The sample can be injected into a nucleic acid sequencer by capillary electrophoresis and sequenced by the sequencer. The nucleic acid sample can be provided on a sample plate insertable into the sequencer wherein the magnetic field does not produce a change in the position of the sample plate relative to the sequencer.

The sample can also be exposed to an electric field to improve elution of the sample. In one embodiment, the electrophoretic apparatus produces an electric field that improves elution of the sample.

A method of performing capillary electrophoresis on a nucleic acid sample is provided comprising introducing the nucleic acid into a capillary electrophoretic apparatus in the presence of a magnetic field under conditions in which capillary electrophoresis is performed on the sample. The method can further include sequencing the sample in a nucleic acid sequencer. The sample can be provided on a sample plate insertable into the sequencer wherein the magnetic field does not produce a change in the position of the sample plate relative to the sequencer.

The magnetic field, which can be formed by a rare earth magnet or electromagnet, attracts one or more magnetic microparticles in the sample. An electric field produced by the electrophoretic apparatus improves elution of the sample into a fluid.

A method of introducing a nucleic acid sample into a nucleic acid sequencer is also provided comprising introducing the nucleic acid into the nucleic acid sequencer in the presence of a magnetic field. The method can further include introducing the sample into the sequencer by capillary electrophoresis and sequencing the sample with the sequencer. The sample can be provided on a sample plate insertable into the sequencer wherein the magnetic field does not produce a change in the position of the sample plate relative to the sequencer.

In particular embodiments, the magnetic field, which can be formed by a rare earth magnet or electromagnet, attracts at least one magnetic microparticle in the sample.

A method of selectively introducing nucleic acid in a sample into a nucleic acid sequencer is further provided in which the sample comprises nucleic acid and magnetic microparticles. The method can further include injecting the sample into the sequencer in the presence of a magnetic field and sequencing the sample in the sequencer. In a particular embodiment, the sample is provided on a sample plate insertable into the sequencer wherein the magnetic field, which can be formed by a rare earth magnet or an electromagnet, does not produce a change in the position of the sample plate relative to the sequencer.

The method can further include injecting the sample into the sequencer by capillary electrophoresis. The sequencer can produce an electric field that improves elution of the sample into a fluid.

A method of selectively introducing nucleic acid in a sample into a nucleic acid sequencer is also provided in which the sample comprises nucleic acid and one or more magnetic microparticles. The method can include introducing the sample into the sequencer using electrokinetic or physical injection, such as pipetting, in the presence of a magnetic field, which can be formed by a rare earth magnet or an electromagnet. The sample can be provided on a sample plate insertable into the sequencer wherein the magnetic field does not produce a change in the geometric positioning of the sample plate relative to the sequencer.

A method is also provided for sequencing a sample comprising nucleic acid and magnetic microparticles, comprising eluting nucleic acid that is bound to the magnetic microparticles from the magnetic microparticles, applying a magnetic field to the sample during electrokinetic or physical injection of the sample into a nucleic acid sequencer, and sequencing the nucleic acid with the sequencer.

A device for applying a magnetic field to a sample that is introduced into an electrophoretic apparatus is provided in accordance with other aspects of the present invention. The device can include one or more magnets, which can include one or more rare earth magnets or electromagnets, attachable to a base (e.g., plate), wherein the device is insertable into the electrophoretic apparatus adjacent a plate containing the sample. In one embodiment, the electrophoretic apparatus is present in a nucleic acid sequencer and the magnetic field does not produce a change in the position of the sample plate relative to the nucleic acid sequencer.

One or more magnetic microparticles can be provided in the sample, wherein the magnetic field attracts the microparticles. The sample can be a nucleic acid sample wherein the nucleic acid is bound to the magnetic microparticles and is introduced into a nucleic acid sequencer by capillary electrophoresis. In a particular embodiment, an electric field produced by the electrophoretic apparatus improves elution of the nucleic acid from the magnetic microparticles.

A device for applying a magnetic field to a plurality of magnetic microparticles during electrokinetic or physical injection of a nucleic acid sample into a nucleic acid sequencer is provided in accordance with further aspects of the present invention. The device can include one or more magnets, which can include one or more rare earth magnets or electromagnets attachable to a plate, wherein the device is insertable into a sequencer adjacent a plate containing the sample. In a particular embodiment, the magnetic field does not produce a change in the position of the sample plate relative to the sequencer.

One or more magnetic microparticles can be provided in the sample, wherein the magnetic field attracts the microparticles. The sample can be injected into the sequencer by capillary electrophoresis. In one embodiment, the sequencer can produce an electric field that improves elution of the sample into a fluid.

A kit is further provided that can include magnetic microparticles and one or more magnets attachable to a plate, and which is insertable into an electrophoretic apparatus adjacent a plate containing the sample. The kit can also include at least one of a reagent to lyse cells, a polyalkylene glycol, an alcohol (e.g., ethanol), and a salt.

### BRIEF DESCRIPTION OF THE DRAWINGS

The patent or application file contains at least one drawing executed in color. Copies of this patent or patent application publication with color drawings will be provided by the Office upon request and payment of the necessary fee.

The foregoing and other objects, features and advantages of the invention will be apparent from the following more particular description of various embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a an exploded isometric view of a device for applying a magnetic field to a sample for introducing the sample into an electrophoretic apparatus.

FIG. 2 is a perspective view of the assembled device of FIG. 2.

FIG. 3 is a side view of the assembled device.

FIG. 4 is a schematic of injection without the magnet plate.

FIG. 5 is a schematic of injection with the magnet plate.

FIG. 6 is an array view of the sequencing results of the inserts cloned in pUC 118 in the presence of the magnet plate (Experiment 1).

FIG. 7 is an array view of the sequencing results of the inserts cloned in pUC 118 in the absence of the magnet plate (Experiment 2).

FIG. 8 is an array view of the sequencing results of the inserts cloned in pUC 118 wherein the samples were magnetically separated from the magnetic beads and pipetted into a new plate free of magnetic beads, and thus, in the absence of the magnet plate (Experiment 3).

FIG. 9a and FIG. 9b show the results of the spatial calibrations performed for calibrating the nucleic acid sequencer.

FIG. 10a and FIG. 10b are agarose gels which demonstrate the advantage of direct injection.

### DETAILED DESCRIPTION OF THE INVENTION

The present invention provides for methods of introducing a sample into an electrophoretic apparatus or nucleic acid sequencer comprising introducing the sample into the electrophoretic apparatus or nucleic acid sequencer in the presence of a magnetic field and devices for use in the methods.

Electrophoresis refers to the migration of a charged particle under the influence of an electric field and is used to separate molecules. There are many different types of electrophoresis, however, all involve the movement of molecules through a conductive medium (e.g., gel) in response to an applied electric field. When charged molecules are placed in an electric field, they migrate toward the positive (anode) or negative (cathode) pole according to their charge. The rate of migration at which a molecule passes through the medium is based on its charge to mass ratio and is referred to as its electrophoretic mobility. Electrophoresis is commonly used to separate biological molecules (e.g., nucleotides, nucleic acids, amino acids, polypeptides) which possess ionisable groups, and therefore, can act as a cation (+) or as an anion (−).

The methods of the present invention can be used with a variety of electrophoretic modes. Types of electrophoresis include gel electrophoresis (e.g., native gels, agarose gels, polyacrylamide gels such as sodium dodecyl sulfate polyacrylamide gel electrophoresis (SDS-PAGE)), electrofocusing gels, pulsed-field gel electrophoresis (PFGE) and capillary electrophoresis (CE). Particular separation modes of CE include capillary gel electrophoresis (CGE), capillary zone electrophoresis (CZE), capillary isoelectric focusing (CIEF), capillary isotachophoresis (CITP), high performance electrophoresis (HPCE) and capillary electrochromatography (packed column chromatography, micellar electrokinetic capillary chromatography (MECC or MEKC)). The methods of the present invention can be used with single, multiple or multiplex capillary electrophoresis (U.S. Pat. No. 5,324,401; U.S. Pat. No. 5,332,480; U.S. Pat. No. 5,277,780; U.S. Pat. No. 5,356,625; U.S. Pat. No. 5,498,324) and capillary array electrophoresis (CAE) systems.

As used herein, an “electrophoretic apparatus” is any suitable apparatus or equipment that can be used to perform electrophoresis. In addition, the methods of the present invention can be used with instrumentation that utilizes electrophoretic apparatus to analyze molecules. For example, determining the sequence of a nucleic acid sequence can be performed in an automated nucleic acid sequencer by capillary electrophoresis. Described herein is a low profile magnet plate compatible with a nucleic acid sequencer. As used herein, a “low profile magnetic plate” refers to a plate that allows for introduction of a nucleic acid sample into the sequencer in the presence of a magnetic field.

Thus, the methods of the present invention can be used with nucleic acid sequencers, such as the Prism Genetic Analyzer (e.g., PE/ABI PRISM™ 3100, 3700 and 3730 Applied Biosystems (ABI)), the Beckman CEQ™ 2000 DNA Analysis System (Beckman Coulter, Inc.), and multicapillary nucleic acid sequencing instruments, such as the MegaBACE™ 1000 DNA Sequencing System (Amersham Pharmacia/Molecular Dynamics, Sunnyvale, Calif.) and the 3700 DNA Analyzer (Perkin-Elmer Biosystems, Foster City, Calif.).

The methods and devices of the present invention can also be used with nucleic acid sequencing methods and nucleic acid sequencers that use a means other than capillary electrophoresis to introduce the nucleic acid sample into the sequencer and/or that use non-Sanger based sequencing techniques. Sequencers that use a means other than capillary electrophoresis include, for example, the Single Molecule Array™ (Solexa), Gene Engine™ Instrument (US Genomics), the DirectMolecular Analyzer™ Analysis (US Genomics), the DirectLinear™ Analysis (US Genomics), and the PicoTiter™ Plate (454 Corp.). Other sequencers include those that can be purchased from SpectruMedix LLC and LI-COR, Inc. In one embodiment, the sample is introduced into the sequencer using an array.

Nucleic acid sequencing methods that use a non-Sanger based technique, include, for example, a polonies method. In this embodiment, the nucleic acid sequencing method can include cloning and amplifying DNA by performing PCR in a thin polyacrylamide film poured on a glass microscope slide. The polyacrylamide matrix retards the diffusion of linear DNA molecules so that the amplification products remain localized near their respective templates. At the end of the reaction, a number of PCR colonies, or ‘polonies’, have formed, each one grown from a single template molecule. See, for example, Mitra, R. D., and Church, G. M., “In Situ Localized Amplification and Contact Replication of Many Individual DNA Molecules,” Nucleic Acids Research, 27(24): i-vi (1999) and Mitra, R. D., et al., “Fluorescent in situ Sequencing on Polymerase Colonies,” Analytical Biochemistry, 320: 55-65 (2003). In this embodiment, a magnetic field can be applied to a nucleic acid sample during introduction of the sample into the acrylamide sequencing device.

In one embodiment, the present invention provides for methods of introducing a sample into an capillary electrophoretic apparatus comprising introducing the sample into the electrophoretic apparatus in the presence of a magnetic field. In capillary electrophoresis, a buffer filled capillary is suspended between two reservoirs filled with buffer. An electric field is applied across the two ends of the capillary. The electrical potential that generates the electric field is in the range of kilovolts. Samples are typically introduced at the high potential end and under the influence of the electrical field. The same sample can be introduced into many capillaries, or a different sample can be introduced into each capillary. Typically an array of capillaries are held in a guide and the intake ends of the capillaries are dipped into vials that contain samples. Each vial can contain the same or different samples as the other vials. After the samples are taken in by the capillaries, the ends of the capillaries are removed from the sample vials and submerged in a buffer which can be in a common container or in separate vials. The samples migrate toward the low potential end. When the samples leave the capillary zones after migrating through the capillary, they are detected by a detector. Capillary electrophoresis techniques and conditions for performing capillary electrophoresis are well known in art (e.g., see Dovich, N.J., et al., Electrophoresis, 18:2393-2399 (1997); Dolnik, V., et al., J. Biochem. Biophys. Meth., 41:103-119 (1999)).

One application of electrophoresis is in DNA sequencing. Prior to electrophoresis analysis, the DNA sample is prepared using well-known methods. Dye-terminator chemistry, which is based on the incorporation of fluorescent dyes into fragments of DNA, is often used for Sanger nucleic acid sequencing. Removing excess unincorporated dye terminators provides for clean accurate DNA sequence data. This is traditionally carried out with organic alcohol precipitation, which can be slow, cumbersome and difficult to automate since three centrifugation steps can be required. The result is a solution of DNA fragments of all possible lengths corresponding to the same total sequential order, with each fragment terminated with a tag label corresponding to the identity of the given terminal base. The separation process employs a capillary tube filled with conductive gel. To introduce the sample, one end of the tube is placed into the DNA reaction vial. After a small amount of sample enters the capillary end, both capillary ends are then placed in separate buffer solutions. A voltage potential is then applied across the capillary tube. The voltage drop causes the DNA sample to migrate from one end of the capillary to the other. Differences in the migration rates of the DNA fragments cause the sample to separate into bands of similar-length fragments. As the bands traverse the capillary tube, the bands are typically read at some point along the capillary tube using one of several detection techniques.

Multiple DNA preparation reactions can be performed in a commercially available microtitre plates or trays (e.g., 96 well plate, 384 well plate, 192 well plate, 768 well plate, and 1536 well plate) and analyzed using electrophoresis. It is not uncommon to analyze several thousand DNA samples for a given DNA sequencing project. Means for analyzing DNA bands in multiple capillaries simultaneously are known in the art (e.g., see U.S. Pat. No. 5,498,324, the contents of which are incorporated herein by reference in their entirety).

Molecular biology applications such as electrophoresis (e.g., capillary electrophoresis) and nucleic acid sequencing require isolation of high quality nucleic acid and polypeptide preparations.

The presence of non-specific sequencing products (e.g., DNA templates, excess PCR primers, non-specific extended and terminated DNA fragments), residual salts, protein (e.g., enzymes), nucleotides, RNA, detergents and contaminants can interfere with capillary electrophoresis. For example, it is essential that DNA template purification techniques remove all the substances likely to interfere with the injection (e.g., electrokinetic) and electrophoresis of samples. The negative ions in the salts are injected into the capillaries during eletrokinetic injection, leading to lower signal. The impurities in the sequencing reaction can also adhere to the walls of the capillary shortening the lifetime of the capillary array. Capillary arrays are expensive, and thus, repeated runnings of badly prepared samples will inevitably lead to an increase in the cost of sequencing.

Salt very much affects the efficiency of loading the nucleic acid to the capillaries used in the automated sequencing machines. The loading process of electrokinetic injection, which is used in some electrophoretic device such as a capillary electrophoretic apparatus, is driven by electric field and because salt ions migrate much faster than the bulky DNA molecules this loading is inefficient in the presence of salts.

A variety of methods for purifying or separating nucleic acid from a solution or mixture are known in the art. A particular method includes the use of magnetic microparticles or beads. Examples of such methods are disclosed in U.S. Pat. No. 5,705,628; U.S. Pat. No. 5,898,071; U.S. Pat. No. 6,534,262; and U.S. Published Application No. 20020106686, the entire teachings of each are incorporated herein by reference. Generally, the methods comprise using appropriate concentrations of salt and polyalkylene glycol to reversibly bind nucleic acid (e.g., selectively bind) which is present in a solution to one or more magnetic microparticles, whose surfaces are coated with one or more functional groups (functional group coated surface) that act as a bioaffinity absorbent for nucleic acid in solution. The magnetic microparticles having nucleic acid bound thereto are subsequently removed, and optionally washed with a buffer, before they are contacted with a suitable elution buffer to elute (e.g., selectively elute) and separate the nucleic acid from the magnetic microparticles. The magnetic microparticles are separated from the elution buffer using, for example, filtration or a magnetic field.

Magnetic microparticles have proven to be inhibitory to the electrokinetic injection of electrophoretic apparatus and nucleic acid sequencers, presumably due to their high mass to charge ratio and injection competition, and thus, require removal prior to injection. For example, microparticles can compete with the injection of nucleic acid into the sequencer and the microparticles appear to occlude the capillaries and reduce the current when too many microparticles are loaded into the capillary. Microparticles, which can have a diameter of 5 micrometers in some embodiments, can create blockages and interference within the inside of the capillary, which can have an inside diameter of about 50 micrometers. Microparticle interference of nucleic acid sequencers can cause delayed starting points and reduced mobility. Magnetic microparticles can be readily removed from the solution with the use of a magnetic field. However, this typically requires at least one additional step of transferring the liquid containing the purified nucleic acid sample to a microparticle-free plate. This step is not only inconvenient and costly, but can compromise the quantity and quality of the purified sample.

Described herein is a low profile magnetic plate compatible with nucleic acid sequencers which allows injection of sample into the sequencer without the need to remove the magnetic beads from the sample. Accordingly, the present invention provides for methods of introducing a sample into an electrophoretic apparatus or nucleic acid sequencer comprising introducing the sample into the electrophoretic apparatus or nucleic acid sequencer in the presence of a magnetic field and devices for use in the methods. In one embodiment, the present invention relates to a method of performing capillary electrophoresis on a nucleic acid sample comprising introducing the nucleic acid into a capillary electrophoretic apparatus in the presence of a magnetic field under conditions in which capillary electrophoresis is performed on the sample. In another embodiment, the present invention relates to a method of introducing a nucleic acid sample into a nucleic acid sequencer comprising introducing the nucleic acid into the nucleic acid sequencer in the presence of a magnetic field.

As used herein, the term “magnetic microparticles” or “magnetic beads” refers to microparticles that respond to an external magnetic field (e.g., a plastic tube or a microtiter plate holder) with an embedded rare earth (e.g., neodymium) magnet but which demagnetize when the field is removed. Thus, the magnetic microparticles are efficiently separated from a solution using a magnet, but can be easily resuspended without magnetically induced aggregation occurring. Particular magnetic microparticles comprise a magnetite rich core encapsulated by a pure polymer shell. Suitable magnetic microparticles comprise about 20-35% magnetite/encapsulation ratio. For example, magnetic microparticles comprising a magnetite/encapsidation ration of about 23%, 25%, 28%, 30%, 32%, or 34% are suitable for use in the present invention. Magnetic microparticles comprising less than about a 20% ratio are only weakly attracted to the magnets used to accomplish magnetic separations. Depending on the nature of the host cell, the viscosity of the cell growth and the nature of the vector (e.g., high or low copy) magnetic microparticles comprising a higher percentage of magnite should be considered. The use of encapsulated magnetic microparticles, having no exposed iron, or Fe₃O₄ on their surfaces, eliminates the possibility of iron interfering with polymerase function in certain downstream manipulations of the isolated DNA. However, the larger the magnetite core the higher the chance of encapsulation leakage (e.g., release of iron oxides). Suitable magnetic microparticles for use in the instant invention can be obtained, for example, from Agencourt Bioscience Corp. (SPRI™ paramagnetic bead technology, CLEANSEQ®, AMPure®, COSMCPrep™, SPRINTPREP™, MCPREP®), Bangs Laboratories Inc., Fishers, Ind. (e.g., Estapor® carboxylate-modified encapsulated magnetic microspheres) and Dynal (e.g., Dynabeads® streptavidin DP).

Suitable magnetic microparticles should be of a size that their separation from solution, for example, by magnetic means or by filtration, is not difficult. In addition, preferred magnetic microparticles should not be so large that their surface area is minimized or that they are not suitable for microscale manipulation. Suitable sizes range from about 0.1 micrometer mean diameter to about 100 micrometers mean diameter. In other embodiments, the size of the magnetic microparticles is from about 1 micrometer mean diameter to about 75 micrometers; from about 10 micrometers to about 50 micrometers; and from about 20 micrometers to about 40 micrometers. A particular size is about 1.0 micrometer mean diameter.

As used herein, the term “functional group-coated surface” refers to a surface which is coated with moieties which reversibly bind nucleic acid (e.g., DNA, RNA or polyamide nucleic acids (PNA)). One example is oligo beads in which the beads use biotin-streptavidin or carbo di-imide coupling. Another example is a surface that is coated with moieties which each have a free functional group which is bound to the amino group of the amino silane or the microparticle; as a result, the surfaces of the microparticles are coated with the functional group containing moieties. The functional group acts as a bioaffinity adsorbent for polyalkylene glycol precipitated DNA. In one embodiment, the functional group is a carboxylic acid. A suitable moiety with a free carboxylic acid functional group is a succinic acid moiety in which one of the carboxylic acid groups is bonded to the amine of amino silanes through an amide bond and the second carboxylic acid is unbonded, resulting in a free carboxylic acid group attached or tethered to the surface of the magnetic microparticle. Suitable solid phase carriers having a functional group coated surface that reversibly binds nucleic acid molecules are, for example, magnetically responsive solid phase carriers having a functional group-coated surface, such as, but not limited to, amino-coated, carboxyl-coated, and encapsulated carboxyl group-coated magnetic microparticles.

Thus, in particular embodiments, the present invention relates to methods of introducing a sample comprising magnetic microparticles into an electrophoretic apparatus or nucleic acid sequencer in the presence of a magnetic field. In one embodiment, the present invention relates to a method of selectively introducing nucleic acid in a sample into a nucleic acid sequencer wherein the sample comprises the nucleic acid and magnetic microparticles, comprising injecting the sample into the sequencer in the presence of a magnetic field. In another embodiment, the invention relates to a method of selectively introducing nucleic acid in a sample into a nucleic acid sequencer, wherein the sample comprises nucleic acid and one or more magnetic microparticles, comprising introducing the sample into the sequencer using electrokinetic or physical injection in the presence of a magnetic field.

Electrophoresis can be used to separate a variety of molecules. Thus, the “sample” for use in the methods of the present invention can be, for example, inorganic anions and cations, drugs, nucleotides, nucleic acids, amino acids and polypeptides. The present invention can be used for the separation and measurement of the species present in samples of biological, ecological, or chemical interest. Of particular interest are macromolecules such as proteins, polypeptides, saccharides and polysaccharides, genetic materials such as nucleic acids, polynucleotides, carbohydrates, cellular materials such as bacteria, viruses, organelles, cell fragments, metabolites, drugs, and the like and combinations thereof. Protein that are of interest include proteins that are present in body fluids such as blood, plasma and spinal fluid (e.g., albumin, globulin, fibrinogen, blood clotting factors, hormones, and the like). Of particular interest are the group of macromolecules that are associated with the genetic materials of living organisms. These include nucleic acids and oligonucleotides such as RNA, DNA (e.g., genomic DNA, cDNA), PNA, their fragments and combinations, chromosomes, genes, as well as fragments and combinations thereof. Other chemicals that can be detected using the present invention include, but is not limited to: pharmaceuticals such as antibiotics, agricultural chemicals such as insecticides and herbicides.

In particular embodiments, the samples are sequencing products such as dye terminator sequencing reaction products, dye primer reaction products, PCR purification products (e.g., PCR amplicons), plasmid purification products (e.g., high copy plasmid purification products, such as from e.g., Coli, and low copy plasmid purification products such as from fosmid and BAC vector based constructs).

As used herein, the term “nucleic acid” is used synonymously with the term polynucleotides and is meant to encompass DNA (single-stranded, double-stranded, covalently closed, and relaxed circular forms), RNA (single-stranded and double-stranded), RNA/DNA hybrids, and polyamide nucleic acids (PNAs).

Samples can be introduced into electrophoretic apparatus or nucleic acid sequencer in a variety of ways. For example, samples can be introduced into an electrophoretic device using physical means (e.g., pipetting), hydrodynamic means (pressure) or electrokinetic injection.

Electrokinetic injection is accomplished by providing a voltage gradient between the source of the sample (e.g., a well or reservoir) and the capillary. The voltage is applied such that the sample flows from the well into a capillary or a well. This voltage is optionally applied by a power source, for example, via electrodes. Specifically, with electrokinetic injection the lead end of the capillary is suspended vertically into a sample vial that contains the sample resuspended in a loading buffer. An electrode is placed into the loading buffer and a potential is applied to drive the sample into the capillary. Once the sample has been introduced, the capillary is removed from the sample loading buffer and placed in a running buffer for the extent of the analysis. The process of electrokinetic injection involves the transfer of charged ions in an electric filed onto the capillary separation matrix. Because ions only transfer in this process, no liquid volume loss occurs from the sample. In other embodiments, a sample can be introduced into the electrophoretic apparatus by physical injection including pipetting, or nucleic acid sequencer arrays and flow cells.

In the methods of the present invention, the samples are introduced into the electrophoretic apparatus or nucleic acid sequencer in the presence of a magnetic field. The magnetic field, which can be formed by a rare earth magnet or electromagnet, attracts one or more magnetic microparticles in the sample. In one embodiment, the magnetic field is formed by neodymium.

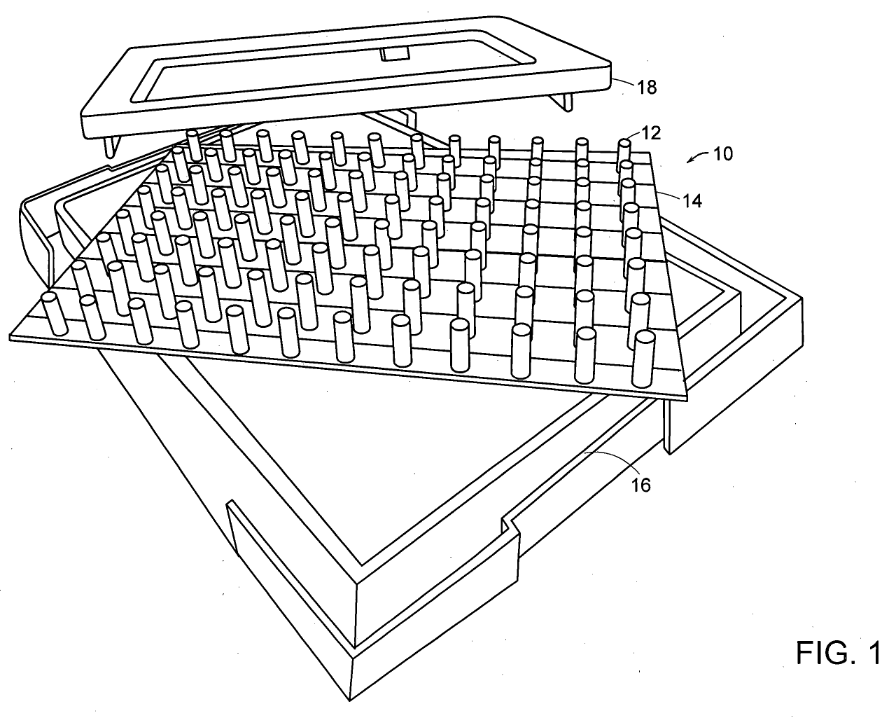

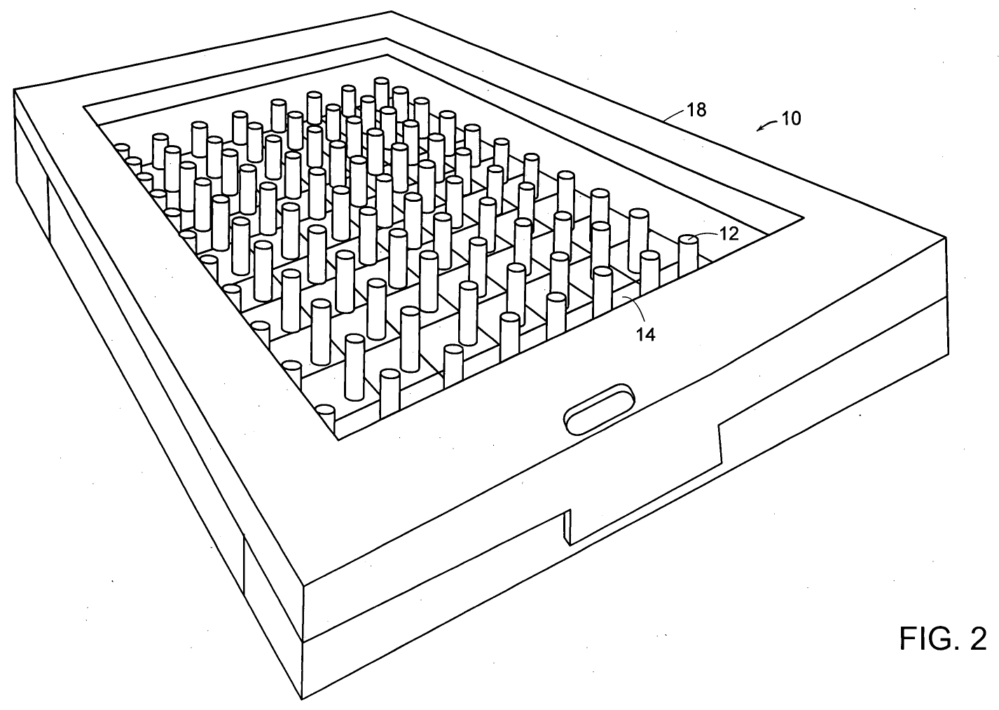

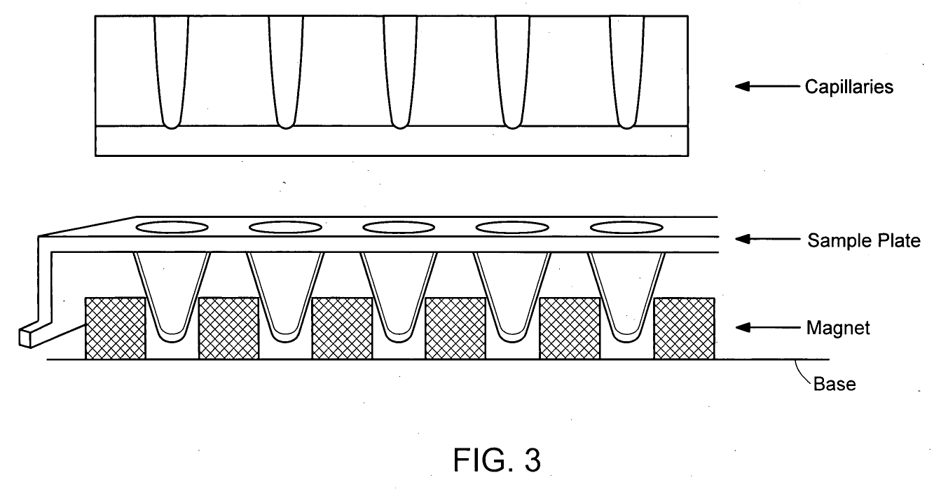

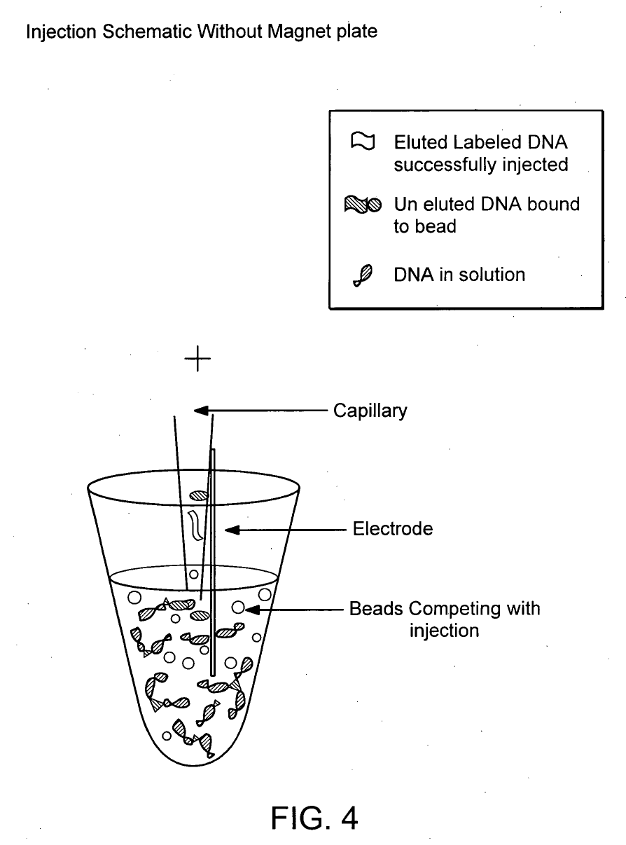

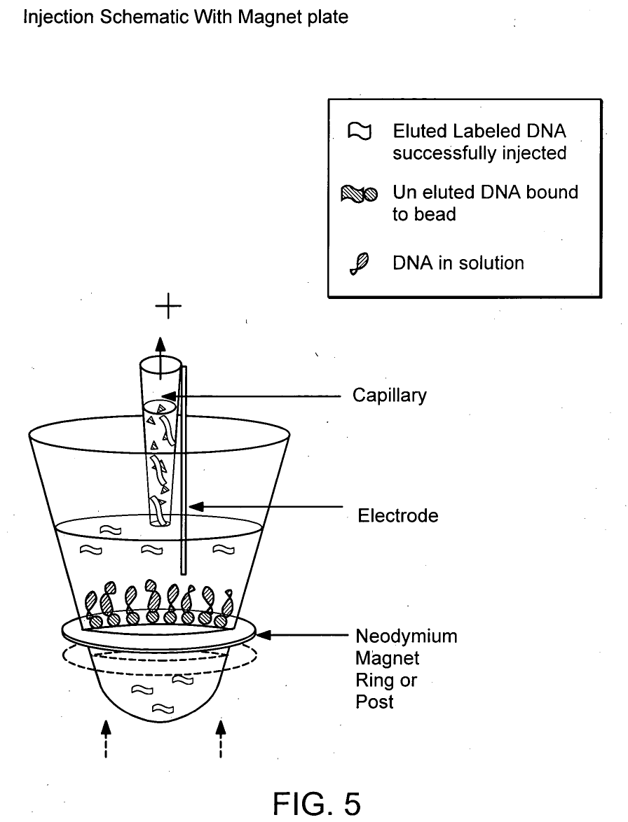

The present invention also relates to a device for applying a magnetic field to a sample for introducing the sample into an electrophoretic apparatus, comprising one or more magnets attachable to a base (e.g., plate), the device being insertable into a sequencer adjacent a plate containing the sample. FIGS. 1 and 2 illustrate a device 10 for applying a magnetic field to a sample for introducing a nucleic acid sample into an electrophoretic device, such as a 3730 DNA Analyzer that can be purchased from Applied Biosystems. In other embodiments, the device 10 can be used with a sequencer that employs hybridization, mass spectrometry, synthesis, or other suitable sequencing techniques.

In one embodiment, the device 10 includes one or more magnets 12 that are attachable to a plate 14. In a particular embodiment, the magnets 12 can include a rare earth magnet, such as neodymium. The plate 14 can be a ferrous material, such as sheet metal, such that the magnets 12 are removably attachable to the plate. In other embodiments, the magnets 12 can be drilled and mounted in position, attached with an adhesive, or otherwise affixed to the plate 14. In further embodiments, one or more electromagnets can be used to form the magnetic field that is used to attract magnetic microparticles provided in a sample. In one embodiment, the magnet field is formed by the rare earth magnet, neodymium.

The plate 14 can be designed to fit within a tray 16, and a cover 18 can be provided above the plate 16 to form the device 10 as illustrated in FIG. 2. Tray 16 and cover 18 can be formed from polypropylene or other suitable materials.

In a particular embodiment, the device 10 is designed to have a low profile so as to be insertable underneath a sample plate disposed in a nucleic acid sequencer without the need to reconfigure the sequencer. In one embodiment, the device 10 produces a magnetic field that does not produce a change in the position of the sample plate relative to the sequencer. By providing a magnetic field on the sample containing the microparticles, introduction or injection of the sample into the sequencer can be performed with the microparticles present in the sample without injection interference from the magnetic microparticles, thereby eliminating the step of removing the magnetic microparticles from the liquid.

Elution of a nucleic acid sample from a solid phase carrier can be challenging to perform, particularly in embodiments in which about 75%, 80%, 85%, 90%, 95%, or 100% elution is desired. As shown herein, electric fields, which can be produced by the electrokinetic injection in the sequencer, can improve the elution process. The methods of the present invention also relate to use of an electric field produced by the electrophoretic apparatus to improve elution of the sample from, for example, a magnetic microparticle. More effective elution can occur by presenting an electric field to a nucleic acid sample bound to magnetic microparticles. In one embodiment, the microparticles are negatively charged wherein the electric field causes the nucleic acid sample bound to the magnetic microparticles to strip off the microparticles and move toward the positive pole. In other embodiments, the microparticles can be positively charged.

A kit is provided in accordance with other aspects of the present invention. In one embodiment, the kit includes magnets 12 and plate 14. The kit can further include tray 16 and cover 18. The kit can also include the embodiments disclosed in U.S. Pat. No. 6,534,262. For example, the kit can include magnetic microparticles, a plate (e.g., a 96-well plate, a magnetic plate such as SPRiPlate® magnetic plate (Agencourt Bioscience Corp.)), a salt (e.g., sodium chloride), a reagent to lyse cells (e.g., sodium hydroxide, sodium doedecyl sulfate (SDS)), polyalkylene glycol (e.g., polyethylene glycol, polypropylene glycol), an alcohol (e.g., ethanol, isopropanol), buffers (e.g., elution buffer, binding buffer), water, or combinations thereof.

In other embodiments, the voltage applied to a sample (e.g., nucleic acid) and/or the ionic strength of the elution buffer can be varied to selectively elute nucleic acid of a particular molecular size from magnetic microparticles. As described herein, U.S. Pat. Nos. 5,705,628 and 5,898,071 disclose methods in which nucleic acid can be selectively eluted from magnetic microparticles. In addition, it is generally known that smaller nucleic acid fragments travel faster than larger fragments under a given electric field such that applying the appropriate injection voltage in an environment where the magnetic microparticles still have some adsorption to the nucleic acids, smaller fragments are biased or favored in the injection. More particularly, smaller fragments of nucleic acid elute at lower voltages, while larger fragments elute at higher voltage. For example, a “low voltage” can have a voltage from about 10 to 15,000 volts in one embodiment, a voltage from about 500 to 10,000 volts in another embodiment, and a voltage from about 1,500 to 5,000 volts in a further embodiment. A “high voltage” can have a voltage from about 16,000 to 50,000 volts in one embodiment, a voltage from about 25,000 to 40,000 volts in another embodiment, and a voltage from about 30,000 to 35,000 volts in a further embodiment.

### EXAMPLE 1

### The Effect of Magnetic Fields in the Presence Electrokinetic Injection

Materials and Methods

Three experiments were performed to assess the effect of magnetic fields in the presence electrokinetic injection. Briefly 96 plasmid subclones (pOT vector) were sequenced and excess dye terminators were purified with CleanSEQ (Agencourt Bioscience corporation, part# 000145) and introduced into the DNA sequencer using three different experimental protocols: 1) with beads (magnetic microparticles from the CleanSEQ kit) and magnet present, 2) with beads and no magnet present, 3) with samples transferred to a new plate free of magnetic beads.

Integration of the magnet plate to the DNA sequencer's sample tray is shown in FIG. 1 and FIG. 2.

Experiment 1

One plate or 96 cDNA inserts cloned in pUC 118 (GenBank™Accession Number (gi) 464017) were cycle sequenced for 40 cycles on ABI GeneAmp 9700 thermocyclers (Applied Biosystems, cat. # 4314487) according to the manufacturer's recommendations. Samples were sequenced with −21 primers (5′GTAAAACGACGGCCAGT3′) (SEQ ID NO: 1) and 1/48thX BigDye V3.0 sequencing reactions (Applied Biosystems cat # 4390436). The samples were then purified using the CleanSEQ kit (Agencourt Biosciences) and eluted in 30 ul ddH20. The purified plate was loaded on an ABI 3730x1 (Applied Biosystems, cat. # 3730x1) with 50 cm array (Applied Biosystems cat # 4305787) and POP7 (Applied Biosystems, cat. # 4332241) and run at 14 kv for 2200 seconds. A 15 second injection time at 1.5 kv was used for the injection of sample and the initial injection was performed with a magnet plate present.

Experiment 2

The identical sequencing samples derived from the 96 cDNA clones mentioned above were re-injected with identical injection parameters, except that the magnet plate was not present. Samples were vortexed and centrifuged to pellet the beads prior to injection.

Experiment 3

The samples were magnetically separated from the magnetic beads and pipetted into a new plate free of magnetic beads and injected under the identical injection conditions as mentioned above.

Results

The sequencing results were analyzed with Phred (Ewing B, Green P (1998) Genome Res. 8:186-194) to assess the base accuracies. The number of phred30 (P30), phred20 (P20), Contiguous phred20 (CP20), phred15(P15), Average phred score (Qual), readlength (Length) and relative fluorescent units (SigA,G,C,T) are reported below (Table 1). Phred scores are a standard measurement of sequence quality, and give highly accurate quality scores for each base; the quality scores are linked to error probabilities. Phred scores are the most commonly used way to assess the quality of sequences is to count the number of bases with a quality score above 20 in the sequence; this number is often called the “Phred20 score”.

A Phred 20 base has an accuracy of 99%, a Phred 30 has an accuracy of 99.9% and a Phred 40 has an accuracy of 99.99%. One can see the results (P30,P20,CP20, P15,Qual, Length, SigAGCT) improved in the “Magnet” experiments compared to the “No Magnet” experiments. Pass rate (number of samples that provide more than 200 P20 bases) also improves in the presence of the magnet plate.

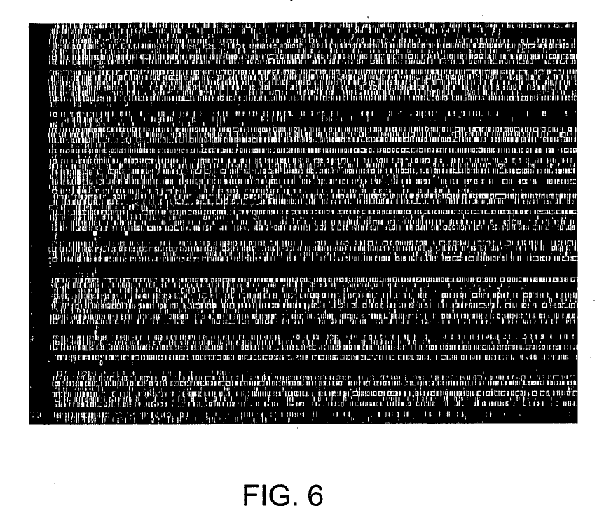

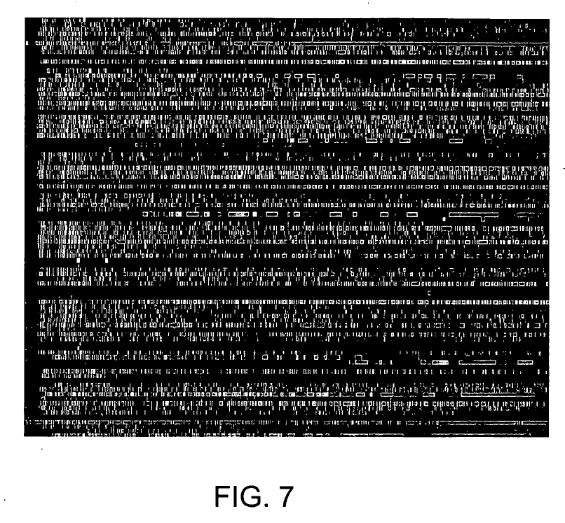

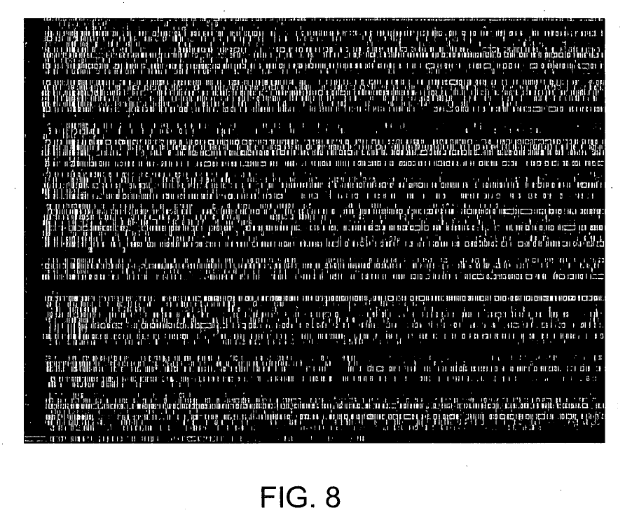

The 3730x1 array views from each experiment are shown in FIG. 6 (Experiment 1), FIG. 7 (Experiment 2) and FIG. 8 (Experiment 3). Further analysis of the samples demonstrated the failed lanes in the samples without the magnet plate are a result of retarded electrophoretic mobility (see bottom 2 smeared lanes in Experiment 2 array view). Coope, et al. describe this artifact with linear polyacrylamide (LPA) based polymers.

TABLE 1

| Seq Barcode | | | Pass | P | P | | P | | | Sig | Sig | Sig | Sig |
|---|---|---|---|---|---|---|---|---|---|---|---|---|---|
| (Machine) | Pass | Total | % | 30 | 20 | CP20 | 15 | Qual | Length | A | G | C | T |
| 000004825549 | 82 | 96 | 85.42 | 565 | 651 | 534 | 687 | 45 | 746 | 1148 | 1542 | 908 | 836 |
| (ZB) Magnet | | | | | | | | | | | | | |
| 000004825649 | 75 | 96 | 78.12 | 529 | 603 | 505 | 635 | 44 | 708 | 506 | 668 | 395 | 363 |
| (ZB) No | | | | | | | | | | | | | |
| Magnet | | | | | | | | | | | | | |
| 000004826749 | 85 | 96 | 88.54 | 562 | 639 | 551 | 670 | 46 | 725 | 361 | 476 | 271 | 254 |
| (ZB) Transfer | | | | | | | | | | | | | |
| | 242 | 288 | 84.03 | 553 | 632 | 531 | 665 | 45 | 727 | 672 | 897 | 525 | 485 |

The 3730x1 array views were also collected to evaluate electrophoresis artifacts. A common artifact of magnetic bead interference is the presence of delayed electrophoretic mobility of samples. This can be seen in the array view of Experiment 2 (FIG. 7) in which lanes 1 and 2 are smeared (Lanes 1-96 from bottom to top, i.e., lower red lane in Experiment 2 (FIG. 7) array view is lane 4).

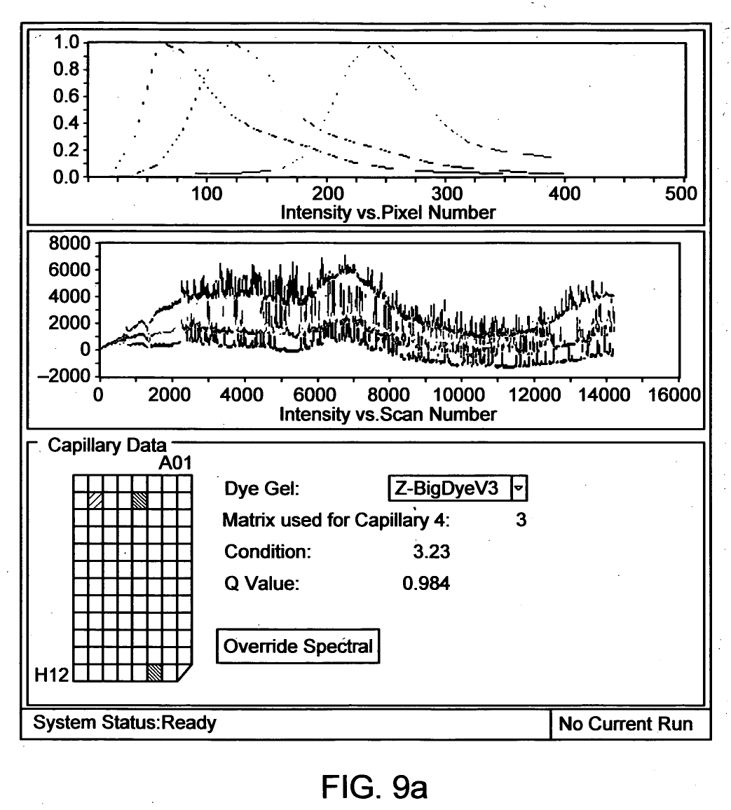

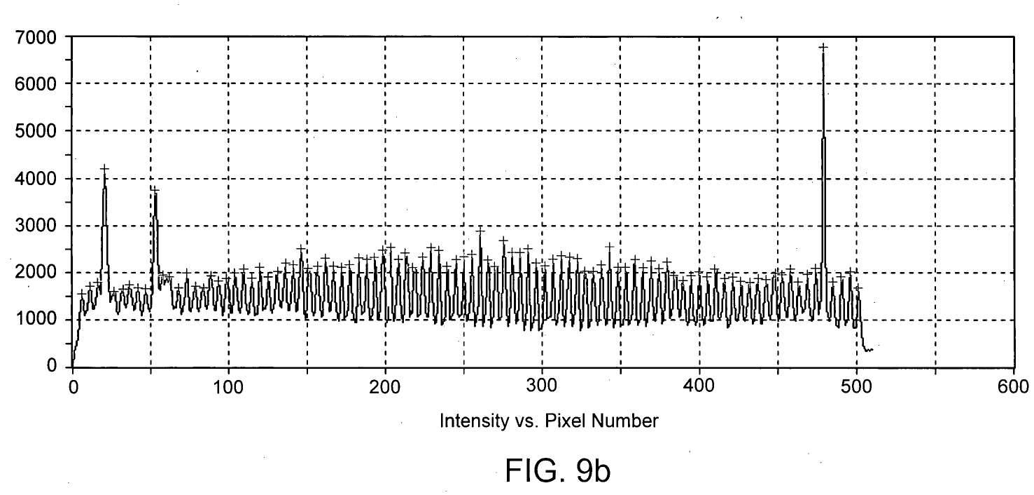

Spatial calibrations performed according to Applied Biosystem's recommendations for calibrating the 3730x1 DNA sequencer were run using DNA control sequencing standards (Applied Biosystems, cat. # 4390309) prior to the experiment to subtract our any calibration related failures from the experiments. The calibration records demonstrate prior existence of 3 poorly performing red capillaries (FIG. 9a and FIG. 9b; see tall blue peaks in FIG. 9b). This proves the read lanes seen in the above array views (Experiments 1-3) are not a result of the experiment but is an instrument artifact present before the run.

### EXAMPLE 2

### Electric Fields Facilitate the Elution Process with High Molecular Weight DNA and Help with Low Molecular Weight DNA

Dye-terminator chemistry has become the gold standard for Sanger DNA sequencing. Removing the excess unincorporated dyes is critical for clean accurate DNA sequence data. This is traditionally done with organic alcohol precipitation which is slow, cumbersome and difficult to automate due to the 3 centrifugation steps required. Magnetic beads have solved this problem (McKeman, et al. U.S. Pat. No. 6,534,262). Agencourt Biosciences, Promega, Edge, and Dynal all sell kits to address this problem.

With newer DNA sequencing polymers (POP7) some magnetic beads have proven to be inhibitory to the electrokinetic injection and require being removed prior to injection.

To circumvent this bead removal step we describe a magnet plate compatible with the 3730 DNA sequencer. This plate allows direct injection with the beads present in the sequencing plate and can occur with minimal injection interference. The design can be readily applied to other sequencers by others skilled in the art.

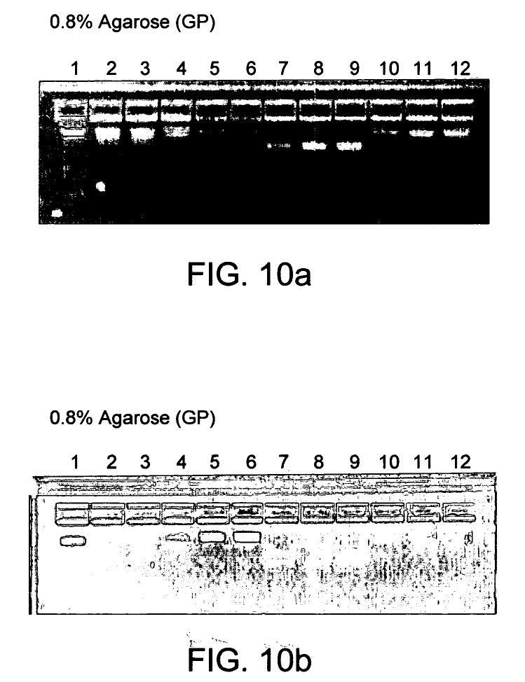

There are theoretical advantages to direct injection. Aqueous elution of DNA from solid phase carriers can be challenging to perform with 100% elution efficiency. An example of Human genomic DNA purified with magnetic particles (Hawkins, et. al., Nucleic Acids Res. 1995; 23:22) demonstrates this effect. The agarose gel in FIG. 10a contains the ddH20 eluant from the beads in lanes 1-6. The eluant was removed from the magnetic particles and loaded on the gel. The gel in FIG. 10b contains replicates of left hand samples loaded on the gel with the magnetic beads and the ddH20 eluant present in which the beads and the DNA were loaded directly onto the gel. More DNA can be seen being eluted from magnetic beads when the beads are exposed to an electric field in the gel suggesting aqueous elution alone is not 100% effective with High Molecular Weight DNA (HMW DNA).

Electric fields can greatly facilitate the elution process with high molecular weight DNA and help with low molecular weight DNA. This is noted in the increased signal seen in the above experiment.

While this invention has been particularly shown and described with references to various embodiments thereof, it will be understood by those skilled in the art that various changes in form and details may be made therein without departing from the scope of the invention encompassed by the appended claims.

1. A method of introducing a sample into an electrophoretic apparatus comprising introducing the sample into the electrophoretic apparatus in the presence of a magnetic field.

2. The method of claim 1, wherein the sample is introduced into the electrophoretic apparatus electrokinetically.

3. The method of claim 1, wherein the magnetic field attracts one or more magnetic microparticles in the sample.

4. The method of claim 3, wherein the microparticles are used to purify dye terminator sequencing reaction products, dye primer reaction products, or a combination thereof.

5. The method of claim 1, wherein the magnetic field is formed by a rare earth magnet.

6. The method of claim 5, wherein the rare earth magnet includes neodymium.

7. The method of claim 1, wherein the magnetic field is formed by an electromagnet.

8. The method of claim 1, wherein the sample is a nucleic acid sample, further comprising injecting the sample into a nucleic acid sequencer by capillary electrophoresis.

9. The method of claim 1, wherein an electric field produced by the electrophoretic apparatus improves elution of the sample into a fluid.

10. The method of claim 1, wherein the sample is a nucleic acid sample and further comprises sequencing the sample in a nucleic acid sequencer.

11. The method of claim 10, wherein the nucleic acid sample is bound to one or more magnetic microparticles.

12. The method of claim 11, wherein the nucleic acid sample is provided on a sample plate insertable into the sequencer and wherein the magnetic field does not produce a change in the position of the sample plate relative to the sequencer.

13. A method of performing capillary electrophoresis on a nucleic acid sample comprising introducing the nucleic acid into a capillary electrophoretic apparatus in the presence of a magnetic field under conditions in which capillary electrophoresis is performed on the sample.

14. The method of claim 13, further comprising sequencing the sample in a nucleic acid sequencer.

15. The method of claim 14, wherein the sample is provided on a sample plate insertable into the sequencer and wherein the magnetic field does not produce a change in the position of the sample plate relative to the sequencer.

16. The method of claim 13, wherein the magnetic field attracts one or more magnetic microparticles in the sample.

17. The method of claim 13, wherein the magnetic field is formed by a rare earth magnet.

18. The method of claim 13, wherein an electric field produced by the electrophoretic apparatus improves elution of the sample into a fluid.

19. A method of introducing a nucleic acid sample into a nucleic acid sequencer comprising introducing the nucleic acid into the nucleic acid sequencer in the presence of a magnetic field.

20. The method of claim 19, further comprising sequencing the sample with the sequencer.

21. The method of claim 20, wherein the sample is provided on a sample plate insertable into the sequencer and wherein the magnetic field does not produce a change in the position of the sample plate relative to the sequencer.

22. The method of claim 19, wherein the magnetic field attracts at least one magnetic microparticle in the sample.

23. The method of claim 19, wherein the magnetic field is formed by a rare earth magnet.

24. The method of claim 20, wherein the sample is introduced into the sequencer by capillary electrophoresis.

25. A method of selectively introducing nucleic acid in a sample into a nucleic acid sequencer wherein the sample comprises the nucleic acid and magnetic microparticles, comprising injecting the sample into the sequencer in the presence of a magnetic field.

26. The method of claim 25, further comprising sequencing the sample in the sequencer.

27. The method of claim 26, wherein the sample is provided on a sample plate insertable into the sequencer and wherein the magnetic field does not produce a change in the position of the sample plate relative to the sequencer.

28. The method of claim 25, wherein the magnetic field is formed by a rare earth magnet.

29. The method of claim 25, wherein the sample is injected into the sequencer by capillary electrophoresis.

30. The method of claim 25, wherein the sequencer produces an electric field that improves elution of the sample into a fluid.

31. The method of claim 25, wherein the nucleic acid is attached to the magnetic microparticles, further comprising selectively eluting the nucleic acid of a particular molecular size from the magnetic microparticles by varying an ionic strength of an elution buffer, applying differential voltage to the nucleic acid, or a combination thereof.

32. A method of selectively introducing nucleic acid in a sample into a nucleic acid sequencer, wherein the sample comprises nucleic acid and one or more magnetic microparticles, comprising introducing the sample into the sequencer using electrokinetic or physical injection in the presence of a magnetic field.

33. The method of claim 32, wherein the magnetic field is formed by a rare earth magnet.

34. The method of claim 32, wherein the sample is provided on a sample plate insertable into the sequencer and wherein the magnetic field does not produce a change in the geometric positioning of the sample plate relative to the sequencer.

35. A method for sequencing a sample comprising nucleic acid and magnetic microparticles, comprising:
a) eluting nucleic acid which is bound to the magnetic microparticles from the magnetic microparticles;
b) applying a magnetic field to the sample during electrokinetic or physical injection of the sample into a nucleic acid sequencer; and
c) sequencing the nucleic acid with the sequencer.

36. A device for applying a magnetic field to a sample that is introduced into an electrophoretic apparatus, comprising one or more magnets attachable to a plate, the device being insertable into the electrophoretic apparatus adjacent a plate containing the sample.

37. The device of claim 36, wherein the magnets include one or more rare earth magnets.

38. The device of claim 36, wherein the magnetic field does not produce a change in the position of the sample plate relative to the sequencer.

39. The device of claim 36, further comprising one or more magnetic microparticles in the sample, wherein the magnetic field attracts the microparticles.

40. The device of claim 36, wherein the sample is a nucleic acid sample and wherein the sample is introduced into a nucleic acid sequencer by capillary electrophoresis.

41. The device of claim 36, wherein an electric field produced by the electrophoretic apparatus improves elution of the sample into a fluid.

42. A device for applying a magnetic field to a plurality of magnetic microparticles during electrokinetic or physical injection of a nucleic acid sample into a nucleic acid sequencer, the device comprising one or more magnets attachable to a plate, the device being insertable into a sequencer adjacent a plate containing the sample.

43. The device of claim 42, wherein the magnets include one or more rare earth magnets.

44. The device of claim 42, wherein the magnetic field does not produce a change in the position of the sample plate relative to the sequencer.

45. The device of claim 42, further comprising one or more magnetic microparticles in the sample, wherein the magnetic field attracts the microparticles.

46. The device of claim 42, wherein the sample is injected into the sequencer by capillary electrophoresis.

47. The device of claim 42, wherein the sequencer produces an electric field that improves elution of the sample into a fluid.

48. A kit, comprising:
(a) magnetic microparticles; and
(b) one or more magnets attachable to a plate, and which is insertable into an electrophoretic apparatus adjacent a plate containing the sample.

49. The kit of claim 48, further comprising at least one of a reagent to lyse cells, a polyalkylene glycol, and a salt.

50. The kit of claim 48, wherein the electrophoretic apparatus is present in a nucleic acid sequencer.


SEQUENCE LISTING (1 sequence)

SEQ ID NO: 1 - DNA, 17 bp, Unknown
  -21 Primer
gtaaaacgacggccagt